(19) United States
(12) Patent Application Publication
(10) Pub. No.: US 2014/0210833 A1
(43) Pub. Date: Jul. 31, 2014

(54) INFORMATION PROCESSING APPARATUS AND CONTROL METHOD FOR INFORMATION PROCESSING APPARATUS

(71) Applicant: KABUSHIKI KAISHA TOSHIBA, Tokyo (JP)

(72) Inventor: Makoto Midorikawa, Hamura-shi (JP)

(73) Assignee: KABUSHIKI KAISHA TOSHIBA, Tokyo (JP)

(21) Appl. No.: 13/975,664

(22) Filed: Aug. 26, 2013

Related U.S. Application Data
(63) Continuation of application No. PCT/JP2013/059047, filed on Mar. 27, 2013.

(30) Foreign Application Priority Data
Jan. 29, 2013 (JP) 2013-014048

(51) Int. Cl. G09G 5/36

(52) U.S. Cl. CPC G09G 5/363
USPC 345/522

(57) ABSTRACT

According to one embodiment, an information processing apparatus includes a main body, a display, a graphics processor, a measuring module, and a storing module. The graphics processor, in the main body, configured to cause the display to display one of wallpapers. The measuring module is configured to measure an amount of power supplied to the main body and the display. The storing module is configured to store amounts of power corresponding to the wallpapers.

### CROSS REFERENCE TO RELATED APPLICATIONS

This application is a Continuation Application of PCT Application No. PCT/JP2013/059047, filed Mar. 27, 2013 and based upon and claiming the benefit of priority from Japanese Patent Application No. 2013-014048, filed Jan. 29, 2013, the entire contents of all of which are incorporated herein by reference.

### FIELD

Embodiments described herein relate generally to an information processing apparatus and a control method for the information processing apparatus.

### BACKGROUND

Electronic devices provided with, for example, a liquid crystal display unit employ structure of enabling a large number of so-called wallpapers to be selected as the base of a display on a display screen. On the other hand, there is, for example, a user's demand for power saving. However, there is no known technique of providing a user with accurate power saving information corresponding to each wallpaper to thereby easily realize power saving by switching wallpapers.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating an example of a personal computer according to an embodiment.

FIG. 2 is a block diagram illustrating the system configuration of the personal computer of the embodiment.

FIG. 3A is a block diagram illustrating the configuration of typical hardware (HW) according to the embodiment.

FIG. 3B is a block diagram illustrating the configuration of HW obtained when a CPU or a GPU is installed in a chip.

FIG. 3C a block diagram illustrating the configuration of HW as one chip model.

FIG. 4 is a flowchart illustrating the entire procedure of a power saving function utilizing switching of wallpapers, employed in the embodiment.

FIG. 5A is a flowchart illustrating a procedure of power measuring processing performed for each wallpaper, employed in the embodiment.

FIG. 5B is a flowchart illustrating another procedure of power measuring processing performed for each wallpaper, employed in the embodiment.

FIG. 6 is a flowchart illustrating yet another procedure of power measuring processing performed for each wallpaper, employed in the embodiment.

FIG. 7 illustrates an example of a list of the power saving levels of the respective wallpapers, employed in the embodiment.

FIG. 8A illustrates a wallpaper D employed in the embodiment.

FIG. 8B illustrates a wallpaper E employed in the embodiment.

### DETAILED DESCRIPTION

Various embodiments will be described hereinafter with reference to the accompanying drawings.

In general, according to one embodiment, an information processing apparatus includes a main body, a display, a graphics processor, a measuring module, and a storing module. The graphics processor, in the main body, is configured to cause the display to display one of wallpapers. The measuring module is configured to measure an amount of power supplied to the main body and the display. The storing module is configured to store amounts of power corresponding to the wall papers.

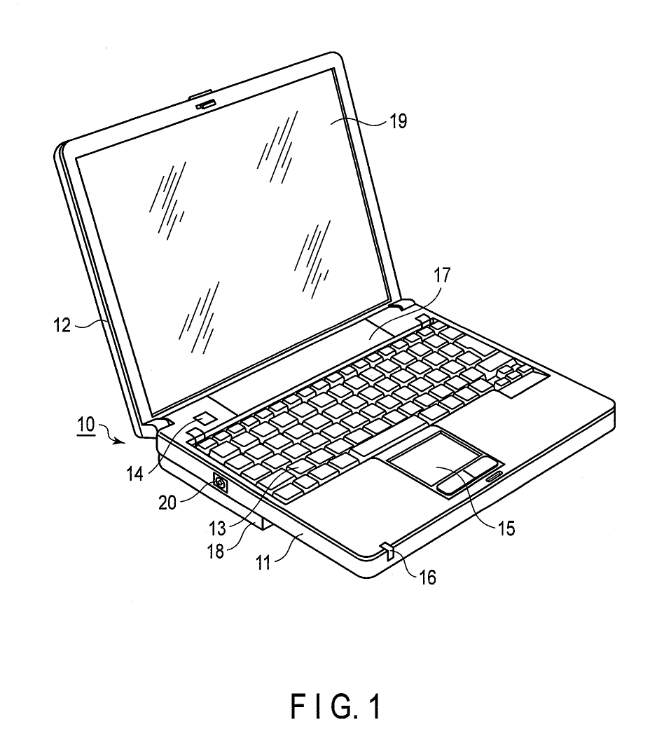

Referring now to FIGS. 1 to 8, an embodiment will be described.

Referring first to FIG. 1, a description will be given of the structure of an electronic device according to the embodiment of an information processing apparatus. This electronic device is realized as a notebook type mobile personal computer 10 powered by, for example, a battery. FIG. 1 is a perspective view of the personal computer 10 viewed from the front side and showing a state in which its display unit is open.

The personal computer 10 includes a computer main body 11 and a display unit 12. The display unit 12 incorporates a display formed of a liquid crystal display (LCD) 19.

The display unit 12 is supported by the computer main body 11 so that it can rotate between an open position in which the upper surface of the computer main body 11 is exposed, and a closed position in which the upper surface of the computer main body 11 is covered with the display unit 12. The computer main body 11 has a thin box-shaped housing, on the upper surface of which a keyboard 13, a power switch 14 for turning on and off the personal computer 10, and a touch pad 15 are provided.

The computer main body 11 is also provided with a power supply connector 20. The power supply connector 20 is provided on a side surface (e.g., the left side surface) of the computer main body 11. An external power supply can be detachably connected to the power supply connector 20. As the external power supply, an AC adaptor can be used. The AC adaptor is a power supply device for converting commercial power (AC power) into DC power.

The power supply connector 20 is formed of a jack, to which a power supply plug led from such an external power supply as an AC adaptor is detachably connectable. A battery 17 is detachably mounted in the rear end portion of the computer main body 11.

The personal computer 10 is powered by the power supplied from the external power supply or the battery 17. When the external power supply is connected to the power supply connector 20 of the personal computer 10, the personal computer 10 is powered by the power supplied from the external power supply. Further, the power of the external power supply is also used for charging the battery 17. The battery 17 may be charged not only when the personal computer 10 is in the ON state, but also when it is in the OFF state. When no external power supply is connected to the power supply connector 20 of the personal computer 10, the personal computer 10 is powered by the power of the battery 17.

An indicator 16 for indicating various power supply states, such as a state in which the external power supply is connected to the main body 11, is provided on the computer main body 11. For instance, the indicator 16 is provided on the front surface of the computer main body 11. The indicator 16 can be formed of an LED. A spacer 18 is also incorporated in the computer main body 11 to keep the rear portion of the main body 11 at a higher level.

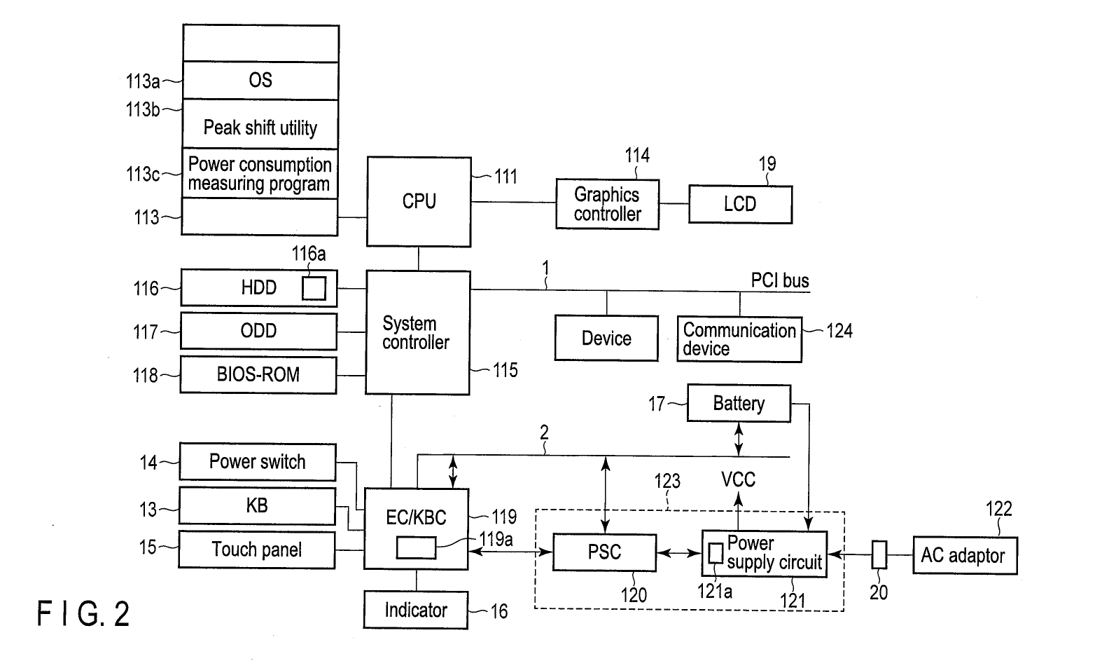

FIG. 2 shows the system configuration of the personal computer 10. The personal computer 10 includes a CPU 111, a main memory 113, a graphics controller (GPU: graphics processing unit) 114, a system controller 115, a hard disk drive (HDD) 116, an optical disk drive (ODD) 117, a BIOS-ROM 118, an embedded controller/keyboard controller (EC/KBC) 119, a power supply controller (PSC) 120, a power supply circuit 121, an AC adaptor 122, etc. The AC adaptor 122 is used as the above-mentioned external power supply. In the embodiment, the power supply controller (PSC) 120 and the power supply circuit 121 cooperate to serve as a power consumption measuring circuit 123 for measuring the amount of power from the external power supply (AC adaptor). The power consumption measuring circuit 123 measures the amount of power not only when the personal computer 10 is in the ON state, but also when it is in the OFF state. In the embodiment, the power supplied from, for example, the external power supply (AC adaptor) is treated as the power consumed by the personal computer 10. The EC/KBC 119 operates to serve as the main unit of the measuring module for measuring the amount of power, reads the data indicating the amount of power (current value, voltage value) measured by the power consumption measuring circuit 123, i.e., indicating the power consumption value, and outputs the read value to the CPU 111 (operating system (OS)) via the system controller 115.

The CPU 111 is a processor for controlling the operation of each component of the personal computer 10. The CPU 111 executes various types of software loaded from the HDD 116 into the main memory 113, such as an operating system (OS) 113a and various types of utility programs or application programs.

The utility programs include a peak shift utility program 113b for realizing a peak shift function. The peak shift function is a function for performing power supply management so that the power supply will be switched from the external power supply (AC adaptor) to the battery during the power consumption peak time zone of the whole community (e.g., daytime, in particular, 13:00 pm to 16:00 pm in summer), and the battery be charged during the time zone in which power consumption is small (e.g., nighttime).

The application programs include a power consumption amount measuring program 113c for processing the data indicating the power consumption value measured by the power consumption measuring circuit 123. The power consumption amount measuring program 113c reads, through the OS 113a, the data indicating the power consumption value recorded in the memory 119a (nonvolatile memory) of the EC/KBC 119, and stores it in the HDD 116. Further, the power consumption amount measuring program 113c executes transmission processing of transmitting, to an external device, the data indicating the power consumption value stored in the HDD 116, data generation processing of generating data to be sent to the external device, display processing of displaying a screen image (e.g., a graph) indicating the amount of power based on the power consumption data, etc. The data generation processing includes data supplement processing for obtaining a required data precision (data amount).

The CPU 111 also executes the basic input output system (BIOS) stored in the BIOS-ROM 118 as a nonvolatile memory. The BIOS is a system program for hardware control.

The GPU 114 is a display controller for controlling the LCD 19 used as the display monitor of the personal computer 10.

The system controller 115 is connected to a PCI bus 1 and communicates with each device connected to the PCI bus 1. For instance, a communication device 124 is connected to the PCI bus 1. Under the control of the CPU 111, the communication device 124 controls communication with external devices (such as a data server) via a network. Further, the system controller 115 contains a serial ATA controller for controlling the hard disk drive (HDD) 116 and the optical disk drive (ODD) 117.

The EC/KBC 119, the power supply controller (PSC) 120 and the battery 17 are connected to each other via a serial bus 2, such as an I²C bus, and are connected to the system controller 115 via an LPC bus. The EC/KBC 119 is a power supply management controller for performing power management of the personal computer 10, and is realized as, for example, a one-chip microcomputer containing a keyboard controller for controlling the keyboard (KB) 13, the touch pad 15, etc. The EC/KBC 119 has a function of turning on and off the personal computer 10 in accordance with user's operation of the power switch 14. The power on and off of the personal computer 10 are controlled by the cooperation of the EC/KBC 119 and the PSC 120. Upon receiving an ON signal from the EC/KBC 119, the PSC 120 controls the power supply circuit 121 to turn on each internal power supply of the personal computer 10. Upon receiving an OFF signal from the EC/KBC 119, the PSC 120 controls the power supply circuit 121 to turn off each internal power supply of the personal computer 10. The EC/KBC 119, the PSC 120 and the power supply circuit 121 are operated by the power supplied from the battery 17 or the AC adaptor 122 even when the personal computer 10 is in the OFF state.

The power supply circuit 121 generates power (operation power) to be supplied to each component, using the power from the battery 17 mounted in the computer main body 11, or the power from the AC adaptor 122 connected as an external power supply to the computer main body 11. When the AC adaptor 122 is connected to the computer main body 11, the power supply circuit 121 generates power (operation power) to be supplied to each component, using the power from the AC adaptor 122, and charges the battery 17 by turning on a charging circuit (not shown). The power supply circuit 121 includes a detection circuit 121a for outputting signals indicating the voltage and current values of the AC adaptor 122 and the voltage and current values of the battery 17. The PSC 120 generates data indicating the current value/voltage value of the AC power supply, and data indicating the current value/voltage value of the battery 17.

The EC/KBC 119, the PSC 120 and the power supply circuit 121 operate to detect data indicating the power consumption value to be measured by the power consumption measuring circuit 123, and to record the data, not only when the personal computer 10 is in the ON state, but also when it is in the OFF state.

When the power supply is in the ON state, the EC/KBC 119 (hereinafter, also referred to as “EC”) immediately outputs the data, received from the PSC 120 and indicating the power consumption value, to the CPU 111 (the OS 113a, the power consumption measuring program 113c) through the system controller 115. The power consumption measuring program 113c records the data in the HDD 116. In contrast, when the power supply is in the OFF state, the EC 119 temporarily stores, in the memory 119a, the data received from the PSC 120 and indicating the power consumption value. When the power supply is turned on, the EC 119 outputs the data to the CPU 111 (the OS 113a, the power consumption measuring program 113c) through the system controller 115. The power consumption measuring program 113c writes this data into the HDD 116.

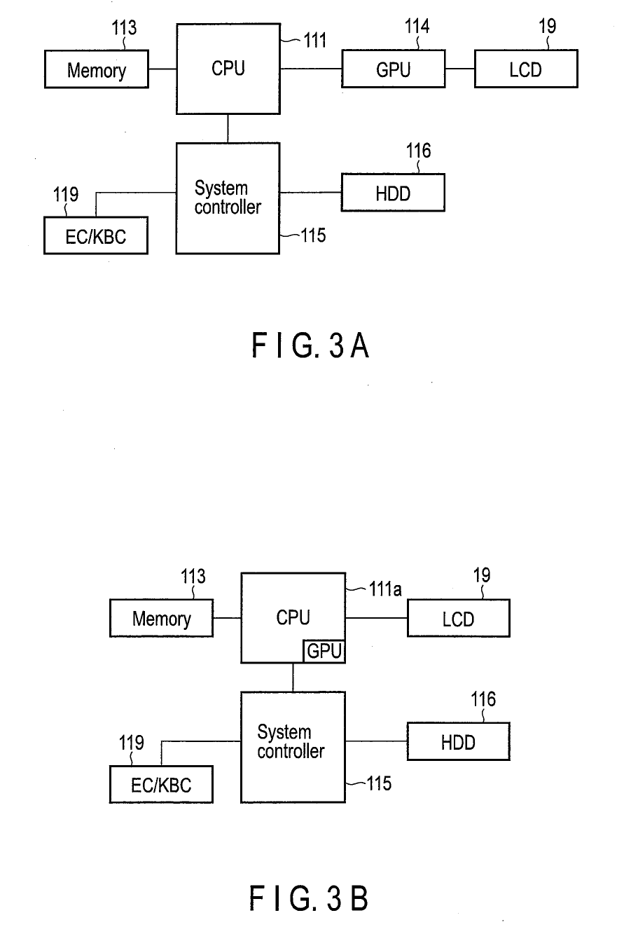

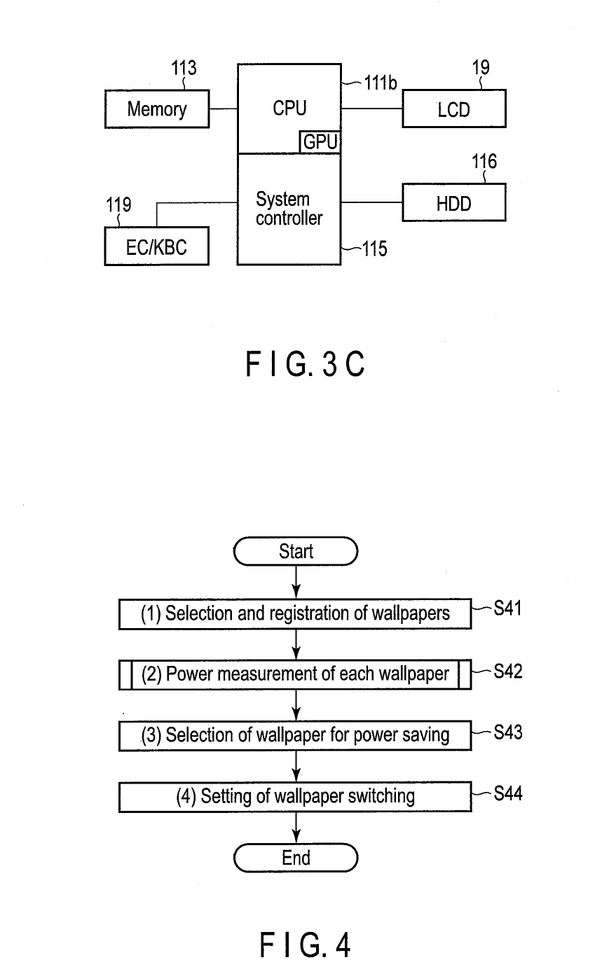

The above-described function of the embodiment is applicable to an apparatus having a display, such as an LCD, and in particular, a graphics (display) having an LED backlight power reduction function (see FIGS. 3A, 3B and 3C). Namely, FIGS. 3A, 3B and 3C show the major configurations of the above-described structures.

FIG. 3A shows a typical HW structure, in which each element corresponds to that denoted by the same reference numeral in FIG. 2. In the example of FIG. 2, a chip set is realized as a single system controller 115.

Further, in the example of FIG. 3B, the function of the graphics processing unit (GPU) 114 in FIG. 3A is incorporated in a CPU 111a. Furthermore, in the example of FIG. 3C, the CPU 111a and the system controller 115 in FIG. 3A are realized as a one-chip model, i.e., a CPU 111b.

A description will now be given of an example in which the power saving function is realized by switching wallpapers. Referring first to FIG. 4, a description will be given of a procedure of processing performed mainly by the CPU 111 when the power saving function (application) utilizing switching of wallpapers is activated.

FIG. 4 shows the entire processing procedure of power saving function, according to the embodiment, which is realized by switching wallpapers.

Step S41: Selection and storing (or registration) of wallpapers are performed. Namely, a user stores (or registers) wallpapers they want to use. A wallpaper that is currently usable is already stored (or registered) as, for example, a default. Other wallpapers may be additionally stored with being set in the same usable state as the default wallpaper. For instance, the user downloads a preferred wallpaper through the Internet, and the CPU 111 writes this wallpaper into the HDD 116.

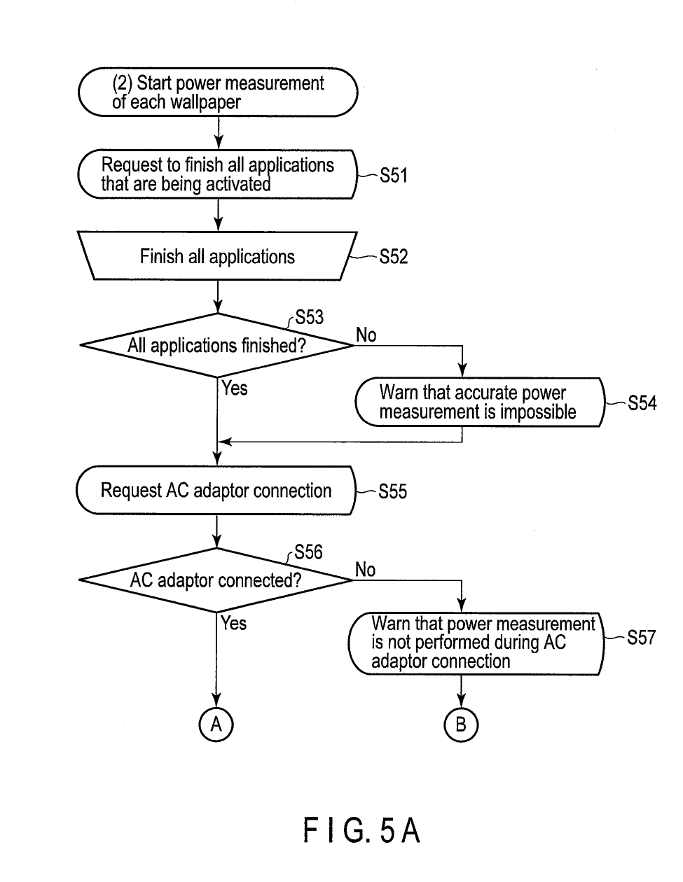

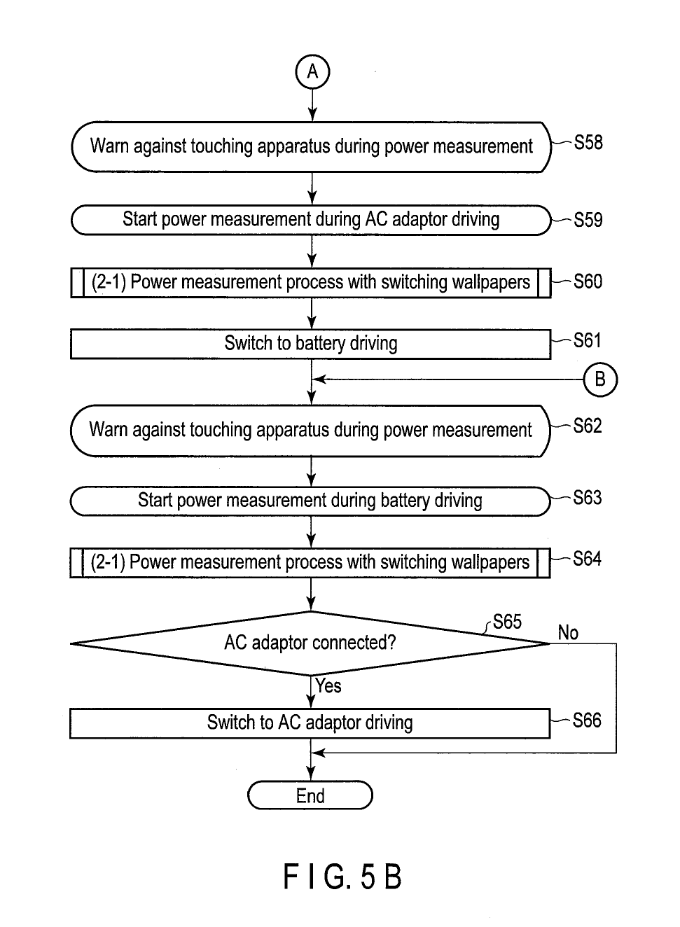

Step S42: Power measurement is performed for each wallpaper. For instance, while switching registered wallpapers from one to another, system power (see Note 1 below) or LED backlight power (see Note 2 below) is measured. Since graphics power saving function setting may vary between the time when the apparatus is powered by an AC adaptor and the time when it is powered by a battery, power measurements are performed both during AC adaptor driving and during battery driving. Referring to the detailed flowcharts of FIGS. 5A and 5B, the power measurements will be described.

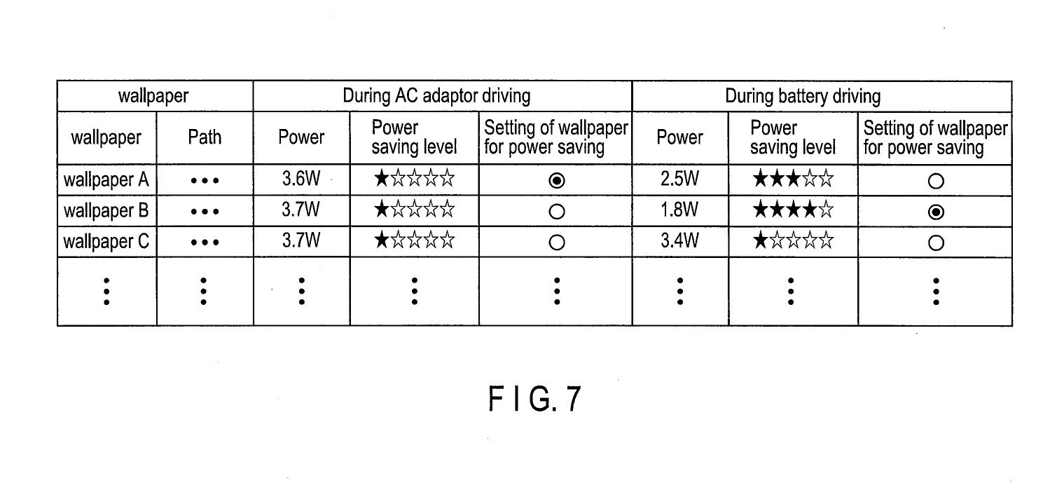

Step S43: A wallpaper for power saving is selected. Specifically, the user selects a power saving wallpaper, referring to the table shown in FIG. 7 that indicates power saving levels corresponding to wallpapers. A most power-saved wallpaper is beforehand selected as a default power saving wallpaper, as will be described in detail referring to FIG. 7.

Step S44: Wallpaper switch setting is performed. The user sets the timing and/or condition for switching of wallpapers.

For instance, the user clicks the right button attached to the touch pad 15 to cause the CPU 11 to display a setting menu on the display (LCD) via the GPU 114. After that, the user opens submenus corresponding to the following items (1) to (3) by clicking, and then selects one of radio buttons corresponding to the items (1) to (3).

The following items (1) to (3) are setting examples of switching. Each of the items (1) to (3) is selectable.

(1) Power saving wallpaper is always used.

(2) Switching to power saving wallpaper is performed when battery driving is performed.

(3) When there is no user operation, switching to power saving wallpaper is performed.

(Note 1: In the Case of System Power)

In the current system, circuits for measuring the system power are generally provided for both AC adaptor driving and battery driving, which means that no additional circuits are needed. However, power calculation during idling is performed as follows:

(A) At the time of AC adaptor driving, DC-IN voltage/current values are measured by the EC 119 (see FIG. 3A), and the system power is calculated.

(B) At the time of battery driving, the battery voltage/current values are measured by the EC 119 (see FIG. 3A), and the battery power is calculated.

(Note 2: In the Case of Directly Measuring LED Backlight Power)

It is necessary to add a current detection resistor across an LED backlight power supply line, and to add a circuit for measuring the voltage/current values of the LED backlight power supply using a microcomputer (EC 119). Compared to the system power, accurate LED backlight power data can be obtained, and the time required for the measurement can be shortened. Namely, for both the AC adaptor driving and the battery driving, the LED backlight voltage/current values are measured using a microcomputer (EC 119), thereby calculating the power.

FIGS. 5A and 5B are flowcharts illustrating detailed subroutines of the above-mentioned step S42, useful in explaining power measuring processing for each wallpaper in the embodiment.

Step S51: The CPU 111 displays, to the user, a request to finish all of the currently operating applications other than the power measurement function.

Step S52: The user clicks a button attached to the touch pad 15 to finish all the applications.

Step S53: The CPU 111 determines whether all the applications are finished. If the answer at this step is Yes, the program skips to step S55, whereas if the answer is No, the subsequent step S54 is executed, and then the program proceeds to step S55.

Step S54: The CPU 111 displays, to the user, a warning message that accurate power measurement may be impossible.

Step S55: The CPU 111 displays, to the user, a request to connect the AC adaptor.

Step S56: The CPU 111 determines whether the AC adaptor is connected. If the answer at this step is Yes, the program proceeds to step S58, whereas if the answer is No, the subsequent step S57 is executed, and then the program skips to step S62.

Step S57: The CPU 111 displays, to the user, a warning message that power measurement during the AC adaptor connection is not performed.

Step S58: The CPU 111 displays, to the user, a warning message not to touch the apparatus during power measurement (to enable measurement of power during idling).

Step S59: The CPU 111 starts to measure power during AC adaptor driving.

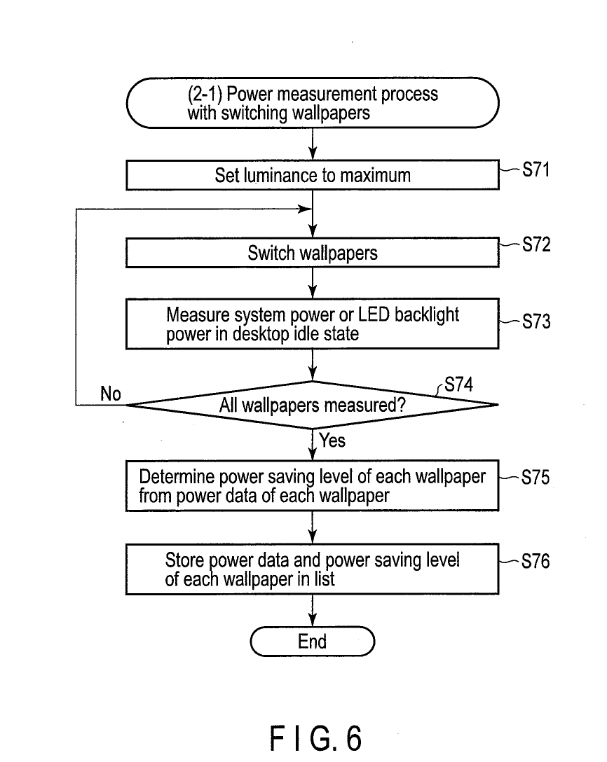

Step S60: The CPU 111 performs power measurement processing while switching wallpapers. This will be described later in detail, referring to FIG. 6.

Step S61: The CPU 111 switches the operation to battery driving, using the power supply circuit 121.

Step S62: The CPU 111 displays, to the user, a warning message not to touch the apparatus during power measurement.

Step S63: The power consumption measuring circuit 123 starts to measure power during battery driving.

Step S64: The CPU 111 performs power measurement processing while switching wallpapers, as at step S60.

Step S65: The CPU 111 determines, via the PSC 120 and the EC/KBC 119, whether the AC adaptor is connected. If the answer at this step is Yes, the program proceeds to the subsequent step S66, whereas if the answer is No, this processing is finished.

Step S66: The CPU 111 switches the operation to AC adaptor driving, and finishes the processing.

FIG. 6 is a flowchart useful in explaining power measurement processing for each wallpaper in the embodiment. This flowchart shows a detailed subroutine of the above-mentioned steps S60 and S64.

Step S71: The CPU 111 sets the luminance at a maximum value (100%).

Step S72: The CPU 111 performs switching of wallpapers.

Step S73: The power consumption measuring circuit 123 measures the system power in a desktop idling state, or measures the LED backlight power.

Step S74: The CPU 111 determines whether measurement has been performed for all wallpapers. If the answer at this step is Yes, the program proceeds to the subsequent step S75, whereas if the answer is No, the program returns to step S72.

Step S75: The CPU 111 determines the level of power saving corresponding to each wallpaper, based on power data corresponding to each wallpaper (see Power saving level in FIG. 7).

Step S76: The CPU 111 stores (registers), in the list described below, power data and a power saving level corresponding to each wallpaper.

FIG. 7 shows an example of a list of power saving levels corresponding to respective wallpapers, employed in the embodiment. This list is stored and maintained in the HDD 116 by the CPU 111. Namely, the CPU 111 and the HDD 116 cooperate to constitute storing module for storing power levels corresponding to the respective wallpapers.

In FIG. 7, power levels, power saving levels and wallpaper settings for power saving are listed in associated with wallpaper IDs, such as A, B, C, . . . , and types of driving, i.e., AC adaptor driving and battery driving. The column “path” indicates link information (specific content, such as directory, is omitted) indicating the location of each wallpaper.

For instance, at the time of AC adaptor driving, the required power (power consumption) of a wallpaper A is 3.6 W, the power saving level of the wallpaper A is represented by one star (the power saving level is represented in five stages, wherein, for example, the highest power saving level is represented by five stars, and the next highest power saving level is represented by four starts). Regarding the wallpaper setting for power saving, a double circle mark attached to the wallpaper A indicates default setting for the use of the wallpaper A, because this wallpaper is at the same power saving level (represented by one star) as the other wallpapers, but requires a smallest power, and is therefore recommendable.

Similarly, at the time of battery driving, the required power (power consumption) of a wallpaper B is 1.8 W, and the power saving level of the wallpaper B is represented by four starts. Since thus, the wallpaper B is most recommendable among all the wallpapers at the time of battery driving, default setting is set for the use of the wallpaper B.

The reason why different determinations are made in power saving level between AC adaptor driving and battery driving is based on, for example, the DPST(R) technique described below.

There are two types of selection for wallpapers. One type of selection is an automatic selection. In this case, the CPU 111 selects a wallpaper of the highest power saving level indicated by the double circle mark from the list stored in the HDD 116, and the GPU 114 displays this wallpaper on the display (LCD).

The other type of selection is a manual selection. In this case, a user operates the touch pad 15 on the list image displayed by the CPU 111 on the display through the GPU 114, to thereby position the cursor at a desired wallpaper. At this time, the user hits the touch pad 15 repeatedly by the fingertip, thereby selecting the wallpaper. The GPU 114 displays this wallpaper on the display. Thus, the user can select a desired wallpaper among wallpapers of relatively high power saving levels after the highest power saving level wallpaper.

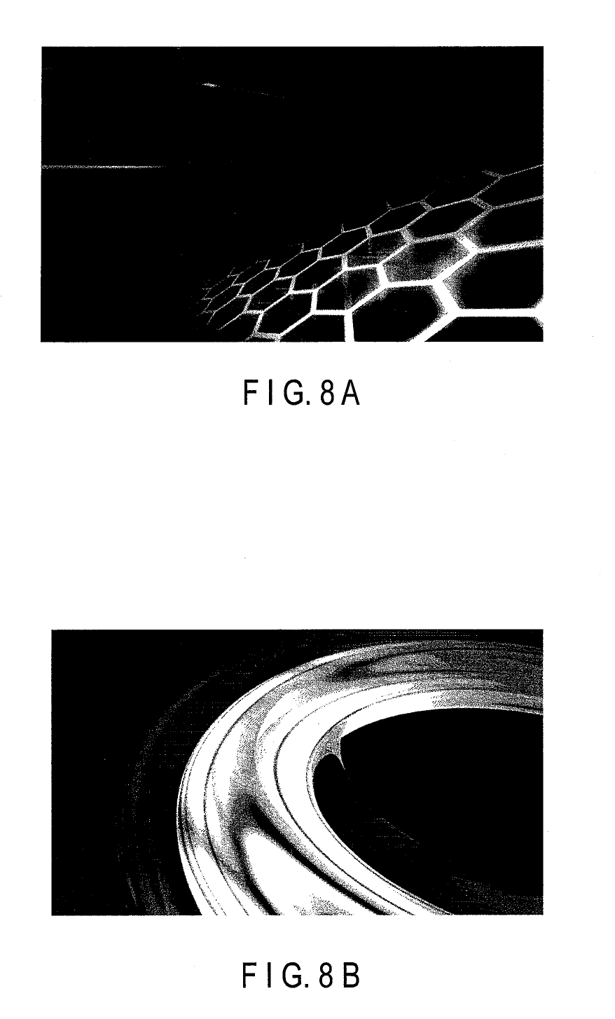

FIG. 8A shows a wallpaper D employed in the embodiment. FIG. 8B shows a wallpaper E. Since the wallpaper D has a darker tone than the wallpaper E, the power consumption of the wallpaper D is generally smaller than that of the wallpaper E. The scheme of selection of wallpapers may be constructed to reduce the time and labor of the user by classifying wallpapers of the same darkness or tone into one group so that selection can be performed simply by analogy without measuring the power consumptions of the wallpapers.

On such a site on a network as in which contracted images are arranged adjacent to each other, when these images are pointed, analogical values of the power consumptions of the images may be calculated, displayed or tentatively stored. In contrast, when the images are actually selected and downloaded, their power consumptions may be measured. The pointing of image can be realized by two ways, i.e., one way of positioning the mouse cursor at the small-sized images, and the other way of right-clicking the mouse after positioning the mouse cursor at the small-sized images.

Further, in general, when a target wallpaper is selected and downloaded, the mouse is left-clicked. As described in relation to step S41, the target wallpaper is stored into the HDD 116 by the CPU 111. Tentative saving is realized by, for example, adding a field to the list, and storing therein a flag indicating tentative saving, and the IDs of the site and the target, along with, for example, analogical values. After downloading, a scheme may be employed, in which determination as to coincidence with wallpapers with flags indicating tentativeness is performed, and then the analogical values are replaced with measurement values obtained when the power saving function (application) is activated to thereby delete the flags.

For reference, a comparison result in the LED backlight power level assumed when DPST(R) is effective will be described. The DPST(R) is an abbreviation of Display Power Saving Technology, and is a power saving function for adjusting the LED backlight power by a graphics display image.

The conditions for measurement are that a GPU (also called Gfx) is a built-in GPU (built-in Gfx), DPST(R) is set “Enable,” effect is set “Max,” the LCD is of 15.6″HD(1366×768), the luminance of the LCD is set to a maximum value (100%), and the driving status is battery driving.

Further, four wallpapers, for example, are used, and the LED backlight power levels required for the wallpaper D (see FIG. 8A) and the wallpaper E (see FIG. 8B) are 1.91 [W] and 3.00 [W], respectively. Further, the LED backlight power level required for white as a single color is 2.47 [W], and that required for black as a single color is 1.35 [W].

Although the graphics power saving function includes a function of controlling the luminance of the LCD depending on a display image to thereby reduce the LED backlight power, the user does not know which wallpaper requires a lower power. Therefore, much further power saving can be realized, if a function is mounted, which measures the power required for each wallpaper the user wishes to use, to detect a wallpaper of the highest power saving effect, and then switch the wallpapers based on the detection.

According to embodiments, the system power in a desktop idle state or the LED backlight power required when each wallpaper is used is measured to detect the power saving level of each wallpaper.

Further, power saving of the whole apparatus can be realized by switching the currently-used wallpaper to a wallpaper of the highest power saving level or the wallpaper selected (designated) by the user, depending upon the status of use, based on the power saving level of each wallpaper detected by the above measurement.

As described above, the embodiment provides an advantage that the desktop idle power can be reduced to reduce the power consumption of the whole apparatus, compared to the prior art, by switching the currently-used wallpaper to a wallpaper of a higher power saving level.

(1) The user can detect which wallpaper is more effective in power saving.

(2) The power of the desktop idling can be reduced to thereby reduce the power consumption of the whole apparatus by switching the currently-used wallpaper to a wallpaper of a higher power saving level.

The present invention is not limited to the above-described embodiments, but may be modified in various ways without departing from the scope.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body;
a display;
a graphics processor in the main body, configured to cause the display to display one of wallpapers;
a measuring module configured to measure an amount of power supplied to the main body and the display; and
a storing module configured to store amounts of power corresponding to the wallpapers.

2. The information processing apparatus of claim 1, further comprising a selection module configured to select, from the wallpapers, a wallpaper which requires a smaller amount of power, based on a list storing the amounts of power corresponding to the wallpapers.

3. The information processing apparatus of claim 2, wherein the selection module is configured to select, from the wallpapers, a wallpaper which requires a smallest amount of power.

4. The information processing apparatus of claim 2, wherein the selection module is configured to select, from the wallpapers, a wallpaper externally designated.

5. A control method for an information processing apparatus comprising a main body, a display, and a graphics processor in the main body, configured to cause the display to display one of wallpapers, comprising:
measuring an amount of power supplied to the main body and the display;
storing amounts of power corresponding to the wallpapers; and
selecting a wallpaper from the wallpapers based on the amounts of power corresponding to the wallpapers.

6. The control method of claim 5, further comprising:
selecting, from the wallpapers, a wallpaper which requires a smaller amount of power, based on a list storing the amounts of power corresponding to the wallpapers.

7. The control method of claim 6, wherein the selecting comprises selecting, from the wallpapers, a wallpaper which requires a smallest amount of power.

8. The control method of claim 6, wherein the selecting comprises selecting, from the wallpapers, a wallpaper externally designated.
